(19) United States
(12) Patent Application Publication
(10) Pub. No.: US 2010/0109185 A1
(43) Pub. Date: May 6, 2010

(54) METHOD AND APPARATUS FOR MANUFACTURING UNEVEN THICKNESS RESIN SHEET

(75) Inventors: Shotaro Ogawa, Minami-Ashigara-shi (JP); Takahiro Hayashi, Minami-Ashigara-shi (JP); Yoshihiko Sano, Minami-Ashigara-shi (JP); Hideo Nagano, Minami-Ashigara-shi (JP); Ryuichi Katsumoto, Minami-Ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 12/593,863

(22) PCT Filed: Mar. 27, 2008
(86) PCT No.: PCT/JP2008/056621

§ 371 Date: Sep. 29, 2009

(30) Foreign Application Priority Data
Mar. 30, 2007 (JP) 2007-091523
Mar. 30, 2007 (JP) 2007-091524

(51) Int. Cl. B29C 47/78

(52) U.S. Cl. 264/177.19; 425/112

(57) ABSTRACT

A method according to the invention comprises an extruding step of extruding molten resin from a die in a belt shape, a molding/cooling step of cooling and solidifying the extruded resin sheet while molding the same in uneven thickness by nipping the same between a mold roller and a nip roller, and a slow cooling step of slowly cooling the resin sheet peeled off the mold roller, and at least the former part of the slow cooling step has a substep of slowly cooling the resin sheet while holding the resin sheet in the original warp-free uneven thickness shape while so applying an external force to the resin sheet as not to obstruct the carriage of the resin sheet.

### TECHNICAL FIELD

The present invention relates to a method for manufacturing an uneven thickness resin sheet and apparatus, and more particularly to a method and apparatus for manufacturing uneven thickness resin sheets for use in various optical elements, such as light guide panels for back lights of liquid crystal display devices and light guide panels for various large displays including those for decorative, exhibiting and illuminating purposes.

### BACKGROUND ART

As resin sheets for use in various optical elements, such resin sheets as Fresnel lenses and lenticular lenses are available, and are used in diverse fields. On the surface of such resin sheets, regular convexes and concaves are formed to enable Fresnel lenses and lenticular lenses to perform their respective optical performances. Various methods have been proposed for use in the manufacture of such resin sheets (see Patent Documents 1 through 7). All these proposed methods use roll forming from the viewpoint of increasing productivity.

For instance, Patent Document 1 describes an attempt to improve transferability by using a special contrivance in the cooling for use until the resin sheet is peeled off the rollers. Patent Document 2 discloses a method of fabricating Fresnel lenses with a metal mold wound around a roller. Patent Document 3 reveals an attempt to enhance productivity and transferability by arranging thermal buffer members inside forming rollers. Patent Document 4 also concerns improvement of transferability and reduction of defects by corona discharge processing.

Patent Documents 5 through 7 concern attempts to manufacture resin sheets excelling in thickness accuracy by heating or cooling both ends and the central part of resin sheets extruded from the die with a view to realizing a high level of thickness accuracy by reducing the distortion of resin sheets.

A typical one of these earlier roll forming methods uses a configuration shown in FIG. 17. This hardware configuration of this method comprises a sheet die 102 for forming a resin sheet 101 molten by an extruding machine (not shown) into a belt shape, a stamper roller 103 on whose surface convexes and concaves are formed, a specular roller 104 arranged opposite the stamper roller 103, and a specular roller 105 for peeling use arranged opposite the stamper roller 103 and on the reverse side to the specular roller 104. The belt-shaped resin sheet 101 extruded from the die 102 is squeezed between the stamper roller 103 and the specular roller 104 to transfer the convexes and concaves of the surface of the stamper roller 103 to the resin sheet 101, and the resin sheet 101 is peeled off the stamper roller 103 by winding it around the specular roller 105 for peeling use.

Specific applications of resin sheets used in these optical elements include back lights of liquid crystal display devices and display devices for decorative and illuminating purposes, and these devices use light guide panels which guide lights from light sources and accomplish surface light emission. For instance, a liquid crystal display device is provided with a back light which irradiates with light rays from the rear side of a liquid crystal display (LCD) panel via a light guide panel and thereby illuminates the LCD panel (see Non-Patent Document 8 for instance).

Light guide panels used on relatively small LCD panels, such as those for mobile telephones or laptop personal computers, are often fabricated by injection molding of molten resin. However, light guide panels of 20 inches or more used on large LCD television sets are fabricated by extrusion molding of molten resin, instead of injection molding which is inapplicable here because of constraints in molding equipment and molding technology.

Usually, for relatively small LCD panels such as those of laptop PCs, wedge shaped light guide panels, thicker toward one end and thinner toward the other as shown in FIG. 18A, are used, and for large LCD panels such as those of large LCD television sets, semicylindrical light guide panels, thicker in the middle and thinner on the two sides as shown in FIG. 18B, are used.

Such uneven thickness resin sheets are usually fabricated by cooling and solidifying each resin sheet extruded from a die while subjecting it to uneven molding and then gradually cooling it. However, this method involves a problem that, in the process of fabricating an uneven thickness resin sheet by extrusion molding, the uneven thickness resin sheet is warped and this warp adversely affects the optical characteristics of the light guide panel equipped with the sheet. In particular, the greater the sheet size, the more susceptible it is to warping, and this is especially true of light guide panels for large LCD panels.

Techniques regarding the prevention of warps, elimination of residual stresses causing warps and control of sheet thickness accuracy in extrusion molding are described in, for instance Patent Documents 9 through 12.
Patent Document 1: Japanese Patent Application Laid-Open No. 8-31025
Patent Document 2: Japanese Patent Application Laid-Open No. 7-314567
Patent Document 3: Japanese Patent Application Laid-Open No. 2003-53834
Patent Document 4: Japanese Patent Application Laid-Open No. 8-287530
Patent Document 5: Japanese Patent Application Laid-Open No. 2002-120248
Patent Document 6: Japanese Patent Application Laid-Open No. 2002-67124
Patent Document 7: Japanese Patent Application Laid-Open No. 2005-349600
Non-Patent Document 8: Kenji Manabe et al., Sumitomo Chemical Co., Ltd., “Development of Acryl Materials and Molding Technology for Liquid Crystal Back Lights, R&D Paper 2002-II (in Japanese)
Patent Document 9: Japanese Patent Application Laid-Open No. 11-320656
Patent Document 10: Japanese Patent No. 3730215
Patent Document 11: Japanese Patent Application Laid-Open No. 2002-120273
Patent Document 12: Japanese Patent Publication No. 6-37065

### DISCLOSURE OF THE INVENTION

However, every one of the methods described in Patent Documents 1 through 7 and 9 through 12 referred to above concerns manufacturing method of resin sheets uniform in thickness in the widthwise direction. Application of any of these known methods to the fabrication of uneven thickness resin sheets having an extensive differentiation of thicknesses (namely being uneven in thickness) in the widthwise direction at the time of molding, such as resin sheets for light guide panels constituting the back lights of liquid crystal display devices, can hardly provide uneven thickness resin sheets free from warping and distortion.

For instance when subjecting a polymethyl methacrylate resin (PMMA) to roll forming after extrusion, it is to be differentiated in thickness in the widthwise direction with a thickness difference between the thickest and thinnest parts of 0.5 mm or more. In this case, a number of problems would occur including the occurrence of convexes and concaves (including shrinkage cavities when resin cures and a differentiation of elasticity recovery quantities) in the front or rear surface, a drop in the overall rate of surface shape transfer to badly affect molding and a failure to transfer a sharp edge shape. In particular, where there is a significant difference in thickness (uneven thickness) in the widthwise direction, the temperature of the resin film immediately after it is extruded from the die in a belt shape permits uniform control in the widthwise direction. However, where the sheet is gradually cooled from the rolled surface or the surface in contact with the external atmosphere, the temperature drops more slowly in thicker parts than in thinner parts, resulting in a temperature differentiation in the widthwise direction. The difference in contraction obviously invites inevitable warping or distortion of the sheet. Though it is conceivable to reduce warping and distortion by slow overall cooling or tensioning, it is extremely difficult to achieve high accuracy in even thickness shaping.

An object of the present invention, attempted in view of these circumstances, is to provide a method for manufacturing an uneven thickness resin sheet and apparatus which can obtain, when fabricating an uneven thickness resin sheet with a significant differentiation in thickness in the widthwise direction at the time of molding, a desired sectional shape free from warping and distortion, especially suitable for use in various light guide panels to be arranged behind various display devices and various optical elements.

In order to achieve the object stated above, a first aspect of the invention provides a method for manufacturing an uneven thickness resin sheet whose thickness is uneven in the widthwise direction of said resin sheet, the method comprising: an extruding step of extruding molten resin from a die in a belt shape, a molding/cooling step of cooling and solidifying the extruded resin sheet while molding the same in uneven thickness by nipping the same between a mold roller and a nip roller, and a slow cooling step of slowly cooling the resin sheet peeled off the mold roller, characterized in that at least the former part of the slow cooling step has a substep of slowly cooling the resin sheet while holding the resin sheet in the original warp-free uneven thickness shape while so applying an external force to the resin sheet as not to obstruct the carriage of the resin sheet.

In the first aspect, at the slow cooling step an external force is so applied to the resin sheet as not to obstruct the carriage of the resin sheet to slowly cool while holding it in its original warp-free uneven thickness shape.

As this enables, even if an internal stress (internal force) which would give rise to a warp within the resin sheet arises at the slow cooling step, as the resin sheet is held in its original warp-free uneven thickness shape by the external force, the sheet is slow-cooled while remaining free from warp, with the internal stress being gradually eased. Even if a warp arises in the resin sheet at the molding/cooling step, as the sheet is slow-cooled in a state of being forcibly corrected from warping by the external force at the slow cooling step, the internal stress which gave rise to the warp is gradually eased.

Therefore, when fabricating an uneven thickness resin sheet by extrusion molding, it is possible to keep the fabricated uneven thickness resin sheet free from warp, and any warp that arose at the molding/cooling step can be corrected at the slow cooling step.

A second aspect of the present invention is characterized in that, in the first aspect, the surface temperature of the resin sheet at the inlet to the slow cooling step is not above the glass transition temperature Tg° C. but not below Tg-30° C., the surface temperature of the resin sheet at the time the external force ceases to be applied is not above Tg-20° C. but not below Tg-80° C., and the external force is not above 200 kgf/cm but not below 10 kgf/cm in line pressure.

In the second aspect, a preferable temperature condition and a preferable pressure condition for the external force to keep the resin sheet in its original warp-free uneven thickness shape are prescribed. By setting the temperature and pressure at these respective levels, the warping of the resin sheet can be corrected even more effectively.

A third aspect of the present invention is characterized in that, in the first or second aspect, the velocity of slow cooling of the resin sheet in the widthwise direction is uniformized.

The uneven thickness resin sheet, because of the unevenness of thickness in the widthwise direction of the resin sheet, is susceptible to differentiation in the velocity of slow cooling, and this differentiation in the velocity of slow cooling is apt to give rise to an internal stress which could invite warping. Therefore, by uniformizing the velocity of slow cooling in the widthwise direction of the resin sheet, the effectiveness of the invention can be further enhanced.

A fourth aspect of the present invention is characterized in that, in any of the first through third aspects, the external force is applied by squeezing the resin sheet between rollers from the front and rear faces thereof and the roller arranged on the side of the uneven thickness shape-face of the resin sheet is formed to follow the uneven thickness shaped-face.

The fourth aspect represents a preferable mode of applying the external force to the resin sheet, wherein the uneven thickness shape of the resin sheet is not damaged by the external force because the external force is applied by squeezing the resin sheet between rollers from the front and rear faces and the roller arranged on the side of the uneven thickness shape-face of the resin sheet is formed to follow the uneven thickness shaped-face. Further, as a gap would hardly arise between the uneven thickness shaped-face and the roller faces, the resin sheet can be accurately held in its original warp-free uneven thickness shape.

A fifth aspect of the present invention is characterized in that, in the fourth aspect, the roller arranged on the uneven thickness shaped-face side is an uneven thickness roller having the same roller face as the uneven thickness shaped-face.

The fifth aspect represents a preferable mode of the roller arranged on the uneven thickness shaped-face side, wherein it is configured of a single uneven thickness roller having the same roller face as the uneven thickness shaped-face. This not only prevents an undue external force from working on the uneven thickness shaped-face but also can accurately hold the resin sheet in its original warp-free uneven thickness shape. For instance, where a semicylindrically shaped uneven thickness resin sheet is used, a concave roller matching the semicylindrical shape is used. Where a wedge-shaped uneven thickness resin sheet is used, a wedge-shaped roller matching the wedge-shape of the sheet is used.

A sixth aspect of the present invention is characterized in that, in the fourth aspect, rollers arranged on the uneven thickness shaped-face side are a plurality of short rollers arrayed in the widthwise direction of the resin sheet.

The sixth aspect represents another preferable mode of rollers to be arranged on the uneven thickness shaped-face side, wherein they are a plurality of short rollers arrayed in the widthwise direction of the resin sheet. This enables a plurality of short rollers to be arranged along the uneven thickness shape, preventing an undue external force from working on the uneven thickness shaped-face but also enabling the resin sheet to be accurately held in its original warp-free uneven thickness shape.

A seventh aspect of the present invention is characterized in that, in any of the fourth through sixth aspects, the roller or rollers arranged on the uneven thickness shaped-face side are an elastic roller or rollers.

The seventh aspect represents another preferable mode of the roller or rollers to be arranged on the uneven thickness shaped-face side, wherein an elastic roller or rollers are used. As this causes, when an external force is applied to the uneven thickness shaped-face, the elastic roller undergoes plastic deformation to follow the uneven thickness shaped-face with the result that not only an undue external force is prevented from working on the uneven thickness shaped-face but also the resin sheet can be accurately held in its original warp-free uneven thickness shape. The uneven thickness shaped roller in the fifth aspect or the short rollers in the sixth aspect may also be elastic roller or rollers.

In order to achieve the object stated above, an eighth aspect of the present invention provides an apparatus for manufacturing uneven thickness resin sheets uneven in thickness in the widthwise direction, the apparatus comprising: an extruding device which extrudes molten resin from a die in a belt shape, a molding/cooling device which cools and solidifies the extruded resin sheet while molding the same in uneven thickness by nipping the same between a mold roller and a nip roller, a slow cooling device which slowly cools the resin sheet peeled off the mold roller, a shape keeping device which holds the resin sheet in the original warp-free uneven thickness shape while so applying an external force to the resin sheet as not to obstruct the carriage of the resin sheet, an external force regulating device which regulates the external force to be applied, and a slow cooling control device which uniformizes the velocity of slow cooling of the resin sheet to be slow-cooled in the widthwise direction.

The eighth aspect represents the configuration of the invention as an apparatus, wherein a shape keeping device, an external force regulating device and a slow cooling control device are provided to enable the resin sheet to be slow-cooled at an appropriate slow cooling temperature while being held in its original warp-free uneven thickness shape.

A ninth aspect of the present invention is characterized in that, in the eighth aspect, the shape keeping device comprises: a first roller arranged on the uneven thickness shaped-face side of the resin sheet and formed to follow the uneven thickness shaped-face, and a straight second roller arranged on the flat face side of the resin sheet. This not only prevents an undue external force from working on the uneven thickness shaped-face but also can accurately hold the resin sheet in its original warp-free uneven thickness shape. As the first roller, for instance, the aforementioned uneven thickness shaped roller, short roller or elastic roller can be suitably used.

In order to achieve the object stated above, a tenth aspect of the present invention provides a method for manufacturing an uneven thickness resin sheet whose thickness is uneven in the widthwise direction of the resin sheet, the method comprising: an extruding step of extruding molten resin from a die in a belt shape, a molding/cooling step of cooling and solidifying the extruded resin sheet while molding the same in uneven thickness by nipping the same between a mold roller and a nip roller, and a slow cooling step of slowly cooling the resin sheet peeled off the mold roller, characterized in that at least one of the molding/cooling step and the slow cooling step has a temperature control substep of so controlling the temperature of the resin sheet with heating device or cooling device as to uniformize the temperature distribution in the resin sheet in the widthwise direction.

In the method for manufacturing uneven thickness resin sheet in the tenth aspect, fabrication is so accomplished as to uniformize the temperature distribution in the resin sheet in the widthwise direction. Therefore, the resultant elimination of temperature differentiation in the widthwise direction can restrain deformation such as distortion or warping and can provide the desired belt shape. Further, the invention relates to a method for manufacturing an uneven thickness resin sheet whereby, when the resin sheet is cooled and molded, the thicker part of the resin film is slower to be cooled and the thinner part is faster. Therefore, by arranging cooling device for the thicker part of the resin film and heating device for the thinner part at the temperature control substep, more accurate temperature control is made possible. Or where only heating device is used, as the cooling velocity of the thinner part is faster, by setting the temperature of the heating device higher for the thicker part of the resin film and lower for the thinner part, appropriate temperature control is made possible.

In order to achieve the object stated above, an eleventh aspect of the present invention provides a method for manufacturing an uneven thickness resin sheet whose thickness is uneven in the widthwise direction of the resin sheet, the method comprising: an extruding step of extruding molten resin from a die in a belt shape, a molding/cooling step of cooling and solidifying the extruded resin sheet while molding the same in uneven thickness by nipping the same between a mold roller and a nip roller, and a slow cooling step of slowly cooling the resin sheet peeled off the mold roller, characterized in that at least one of the molding/cooling step and the slow cooling step has a temperature control substep of so controlling the temperature of the resin sheet with a heating device or a cooling device as to cause the temperature distribution in the resin sheet in the widthwise direction to keep a prescribed temperature distribution pattern.

In order for the final product to be molded free from distortion or warping, the temperature distribution in the widthwise direction of the resin sheet may not be necessarily uniform depending on the uneven thickness shape of the final product. For instance, where the temperature distribution in the resin sheet when it is peeled off the rollers has a specific distribution pattern, the sheet may be molded free from distortion or warping. In this case, it is necessary to so perform control as to achieve that specific temperature distribution pattern.

In the method for manufacturing uneven thickness resin sheet in the eleventh aspect, fabrication is so accomplished as to conform the temperature distribution in the resin sheet in the widthwise direction to a prescribed temperature distribution. Even if the temperature distribution in the resin sheet in the widthwise direction is made uniform, distortion or warping may be formed depending on the shape. Since the eleventh aspect of the invention enables the resin sheet to be molded in a temperature distribution immune from distortion or warping, the method can be applied to sheets of a wide variety of shape.

An twelfth aspect of the present invention is characterized in that, in the tenth or eleventh aspect, at the temperature control substep the temperature distribution in the resin sheet in the widthwise direction is detected with a sensor and temperature control in the widthwise direction is performed according to the detected value.

In the twelfth aspect, the temperature distribution in the resin sheet is detected with a sensor, and temperature control is so accomplished as to cause the temperature distribution in the resin film in the widthwise direction to conform to a prescribed temperature distribution pattern. Therefore, the accuracy of temperature control can be enhanced. Further, it is preferable for the temperature control in this arrangement to be automatic.

A thirteenth aspect of the present invention is characterized in that, in the twelfth aspect, for the temperature control substep a plurality each of the sensors and the heating device or the cooling device are installed in the widthwise direction of the resin sheet.

In the thirteenth aspect, as a plurality each of sensors and the heating device or the cooling device are installed in the widthwise direction of the resin sheet, the accuracy of temperature control can be enhanced.

A fourteenth aspect of the present invention is characterized in that, in the thirteenth aspect, the positions of the sensors and the heating device or the cooling device can be altered in the widthwise direction according to the sectional shape of the final product.

The fourteenth aspect, as the positions of the sensors and the heating device or the cooling device s are variable, can be adapted to final products of a variety of sectional shapes.

A fifteenth aspect of the present invention is characterized in that, in any of the tenth through fourteenth aspects, the method is performed by using a peeling roller for peeling the resin sheet off the mold roller and a slow cooling zone for performing the slow cooling step, and the sensor and the heating device or the cooling device are installed in two or more parts selected from the mold roller part, the peeling roller part and the slow cooling zone.

In the fifteenth aspect, as sensors and the heating device or the cooling device are installed in two or more substeps of the fabrication process, temperature control is made possible at a plurality of steps, and the accuracy of temperature control, and accordingly of shape control, can be enhanced.

A sixteenth aspect of the present invention is characterized in that, in any of the tenth through fifteenth aspects, the uneven thickness resin sheet after transferring the convexes and concaves of the mold roller surface has a thickness difference between the thickest and thinnest parts of 0.5 mm or more in the widthwise direction of the sheet.

A seventeenth aspect of the present invention aspect is characterized in that, in any of the tenth through sixteenth aspects, the thickness of the thinnest part of the uneven thickness resin sheet is not more than 5 mm.

The sixteenth and seventeenth aspects prescribe the thickness of resin sheets to be fabricated by the manufacturing method according to the invention. The manufacturing method according to the invention, as it allows control of the temperature of resin sheets, provide resin sheets of which molding such as distortion and warping are restrained even for resin sheets having a large difference between the thickest and thinnest parts or resin sheets having significantly great thickness. Thus, the invention can prove effectiveness in the molding of resin sheets having a sectional shape which conventionally is difficult to mold.

An eighteenth aspect of the present invention is characterized in that, in any of the tenth through seventeenth aspects, at the temperature control substep the resin sheet is heated or cooled from both faces.

In the eighteenth aspect, as the resin sheet is heated or cooled from both faces, control can be so accomplished as to uniformize the temperature in the depthwise direction of the resin sheet even where the resin sheet is particularly thick.

A nineteenth aspect of the present invention is characterized in that, in any of the tenth through eighteenth aspects, the resin sheet contains diffusing particles.

In the nineteenth aspect, as the resin sheet contains diffusing particles, light rays propagating within this resin film are diffused, contributing to enhanced uniformity of light rays from the source light emitted from this resin film.

In order to achieve the object stated above, a twentieth aspect of the present invention provides an apparatus for manufacturing uneven thickness resin sheets uneven in thickness in the widthwise direction, comprising: an extruding device which extrudes molten resin from a die in a belt shape, a molding/cooling device which cools and solidifies the extruded resin sheet while molding the same in uneven thickness by nipping the same between a mold roller and a nip roller, and a slow cooling device which slowly cools the resin sheet peeled off the mold roller, characterized in that at least one of the molding/cooling device and the slow cooling device has a temperature control device which so controls the temperature of the resin sheet with a heating device or a cooling device as to uniformize the temperature distribution of the resin sheet in the widthwise direction.

In order to achieve the object stated above, a twenty-first aspect of the present invention provides an apparatus for manufacturing uneven thickness resin sheets uneven in thickness in the widthwise direction, comprising: an extruding device which extrudes molten resin from a die in a belt shape, a molding/cooling device which cools and solidifies the extruded resin sheet while molding the same in uneven thickness by nipping the same between a mold roller and a nip roller, and a slow cooling device which slowly cools the resin sheet peeled off the mold roller, characterized in that at least one of the molding/cooling device and the slow cooling device has a temperature control device which so controls the temperature of the resin sheet with a heating device or a cooling device as to cause the temperature distribution of the resin sheet in the widthwise direction to keep a prescribed temperature distribution pattern.

In the twentieth and twenty-first aspects, the invention is configured as apparatuses.

The method and apparatus for manufacturing uneven thickness resin sheet according to the invention can provide a desired sectional shape free from warping and distortion when fabricating an uneven thickness resin sheet with a significant differentiation in thickness in the widthwise direction at the time of molding. Therefore, the invention can provide a method for manufacturing an uneven thickness resin sheet and apparatus especially suitable for use in various light guide panels to be arranged behind various display devices such as LCD devices and various optical elements.

### BRIEF DESCRIPTION OF THE DRAWINGS

FIG. 1 charts the flow of executing a method for manufacturing an uneven thickness resin sheet in first and second embodiments of the invention;

FIG. 2 conceptually illustrates an apparatus for manufacturing uneven thickness resin sheet in the first embodiment of the invention;

FIG. 3A and FIG. 3B illustrate the configuration of molding and cooling rollers;

FIG. 4 shows an expanded view of the molding and cooling rollers;

FIG. 5 illustrates the temperature distribution in a resin sheet in the widthwise direction at the molding/cooling step and the slow cooling step;

FIG. 6A through FIG. 6E illustrate cooling a control device and a slow cooling control device which give rise to a temperature differentiation;

FIG. 7 illustrates an example of a shape keeping device;

FIG. 8 illustrates a shape keeping device in another mode;

FIG. 9 illustrates a shape keeping device in still another mode;

FIG. 10 illustrates warping of a resin sheet;

FIG. 11 illustrates a control system for an apparatus for manufacturing uneven thickness resin sheet;

FIG. 12 illustrates equipment items driven by the control system of the apparatus for manufacturing uneven thickness resin sheet;

FIG. 13 shows the configuration of an apparatus for manufacturing uneven thickness resin sheet in the second embodiment of the invention;

FIG. 14 shows the configuration of the molding/cooling step and the slow cooling step in the apparatus for manufacturing uneven thickness resin sheet in the second embodiment of the invention;

FIG. 15A through FIG. 15C show sections of examples of a molded uneven thickness resin sheet in the second embodiment of the invention;

FIG. 16 shows a view from underneath of the mold roller part on the production line of uneven thickness resin sheets in the second embodiment of the invention, wherein the arrangement of a heating device and sensors is illustrated;

FIG. 17 shows the configuration of a conventional resin sheet production line; and

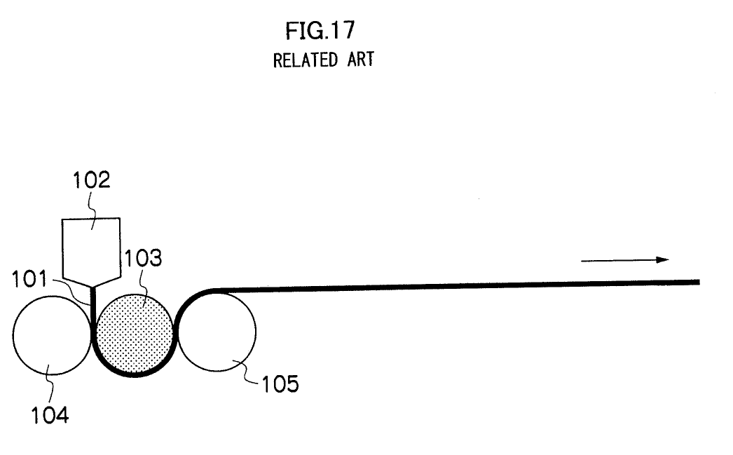

FIG. 18A and FIG. 18B illustrate examples of the shape of an uneven thickness resin sheet.

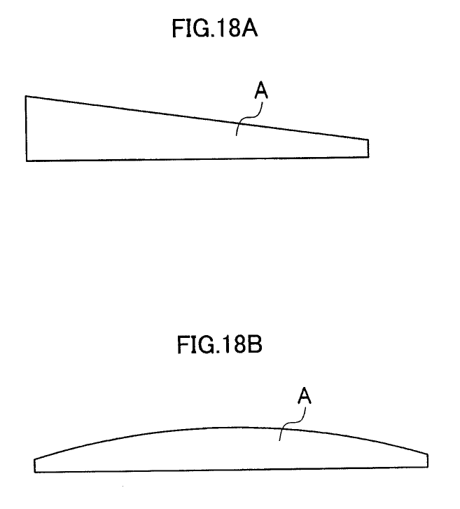

### DESCRIPTION OF SYMBOLS

10 Raw material preparing step
12 Extruding step
14 Molding/cooling step
16 Slow cooling step
18 Warp measuring step
20 Control step
22 Laminating step
24 Trimming/cutting step
26 Loading step
28 Raw material silo
30 Additive silo
32 Automatic measuring machine
34 Mixer
36 Hopper
38 Extruder
40 Constant volume pump
42 Feed pipe
44 Die
46 Mold roller
48 Nip roller
50 Peeling roller
52 Cooling control device
53 Channel
54 Slow cooling zone
55 Heat insulator
56 Shape keeping device
58 Concave roller
60 Roller
62 Short rollers
64 Long roller
66 Bearing
68 Air cylinder
70 Bearing
74 Air nozzle device
76 Feed roller
78 Warp measuring instrument
79 Stocker
80 measuring table
82 Reel
84 Protective film
86 Nip roller
88 Cutter
90 Trimmer
122, 124, 126, 128, 129 Heating device (or cooling device)
130, 132, 133, 134, 135 Sensor

### Best Embodiment of the Invention

The method and apparatus for manufacturing uneven thickness resin sheet in preferred embodiments of the present invention will be described below with reference to the accompanying drawings.

### First Embodiment of the Invention

In a first preferred embodiment of the invention, there is provided an uneven thickness resin sheet manufacturing technique by which an uneven thickness resin sheet molded at a molding/cooling step is prevented from being warped or distorted in being slow-cooled at a slow cooling step. It further is a technique by which any warp that arose at the molding/cooling step is corrected at the slow cooling step. This description of the first embodiment of the invention will refer to a semicylindrically shaped uneven thickness resin sheet.

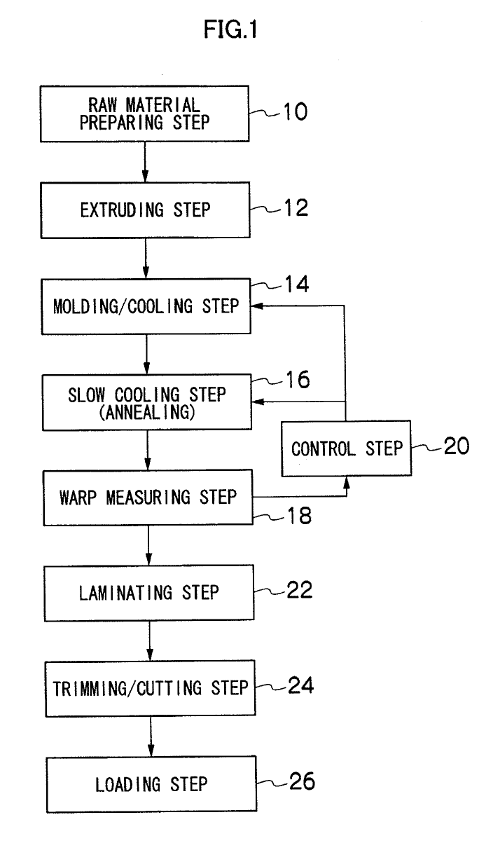

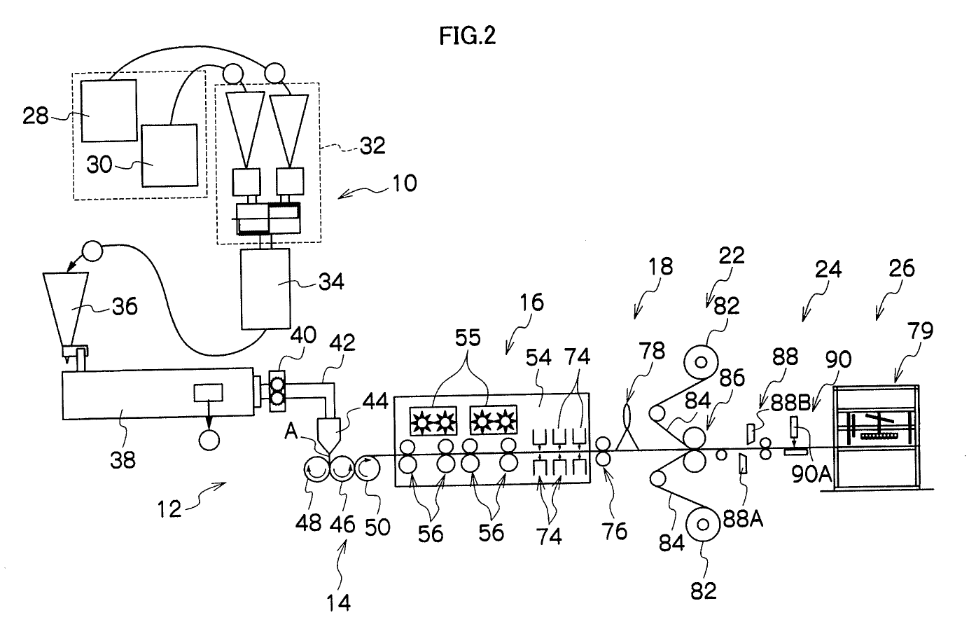

FIG. 1 charts an example of overall flow of executing a method for manufacturing an uneven thickness resin sheet, and FIG. 2 conceptually illustrates an apparatus for manufacturing uneven thickness resin sheet in the first embodiment of the invention equipped with various items for executing the steps of the process.

As charted in FIG. 1, the method for manufacturing uneven thickness resin sheet according to the invention comprises a raw material preparing step 10 at which mainly the raw material is measured and mixed, an extruding step 12 at which molten resin is continuously extruded in a belt shape, a molding/cooling step 14 at which the extruded resin sheet A is solidified by cooling while being subjected to uneven thickness molding, a slow cooling step 16 at which the solidified resin sheet A is slow-cooled, a warp measuring step 18 at which whether or not the slow-cooled resin sheet A meets a prescribed standard regarding any warp, a control step 20 at which, if the warp surpasses the prescribed standard, control is so performed as to uniformize the velocity of cooling and the velocity of slow cooling in the widthwise direction of the resin sheet by feeding back the fact of excessive warping to the molding/cooling step 14 and the slow cooling step 16, a laminating step 22 at which a surface-protective film is laminated over each of the front and rear faces of the resin sheet A, a trimming/cutting step 24 at which the resin sheet A is trimmed and cut to a prescribed size (length by width), and a loading step 26 at which the trimmed and cut resin sheet A is loaded.

The configuration of the apparatus for manufacturing uneven thickness resin sheet according to the invention will be described below with reference to each of steps 10 through 26.

As shown in FIG. 2, the raw material preparing step 10, a raw material resin and additives fed from a raw material silo 28 (or raw material tank) and an additive silo 30 (or additive tank) to an automatic measuring machine 32 are automatically measured, and the raw material resin and the additives are mixed in a mixer 34 in prescribed proportions.

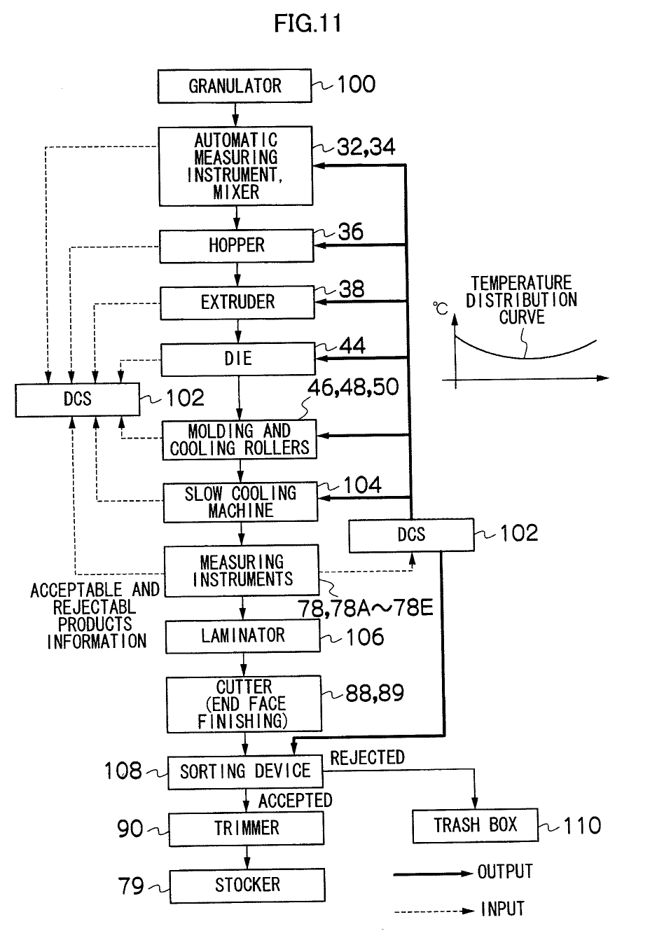

When scattering particles (also known as diffusing particles) are to be added to the raw material resin as an additive, a master batch system can be suitably used by which master pellets are prepared with a granulator 100 (see FIG. 11) in advance by adding scattering particles to the raw material resin in a higher concentration than the prescribed, and mixed in the mixer 34 with base pellets (to which scattering particles are not added) in a prescribed ratio. The same applies where any other additive than scattering particles is to be added.

The raw material resin for use in the invention can be selected from thermoplastic resins including, for instance, polymethyl methacrylate resin (PMMA), polycarbonate resin (PC), polystyrene resin (PS), MS resin, AS resin, polypropylene resin (PP), polyethylene resin (PE), polyethylene terephthalate resin (PET), polyvinyl chloride resin (PVC) and thermoplastic elastomers, or copolymers or cycloolefin polymers thereof. The raw material resin appropriately measured and mixed at the raw material preparing step 10 is fed to the extruding step 12.

At the extruding step 12, the raw material resin mixed in the mixer 34 is inputted to an extruder 38 via a hopper 36, and is melted in the extruder 38 while being kneaded. The extruder 38 may be either a single-axis extruder or a multi-axis extruder, and preferably should have a vent function to vacuumize the inside of the extruder 38. The raw material resin melted in the extruder 38 is fed by a constant volume pump 40, which may be a screw pump, a gear pump or the like to a die 44 (e.g. a T die) via a feed pipe 42. The resin sheet A extruded in a belt shape from the die 44 is then fed to the molding/cooling step 14.

At the molding/cooling step 14, the resin sheet A extruded from the die 44 is cooled and solidified while being nipped by a mold roller 46 and a nip roller 48 into an uneven thickness shape, and the solidified resin sheet A is peeled with a peeling roller 50. These rollers 46, 48 and 50 will be hereinafter collectively referred to as molding and cooling rollers.

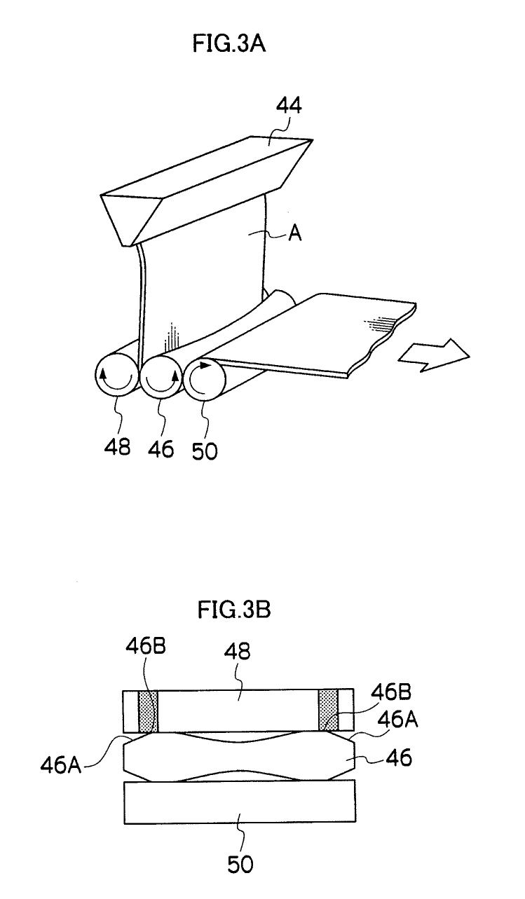

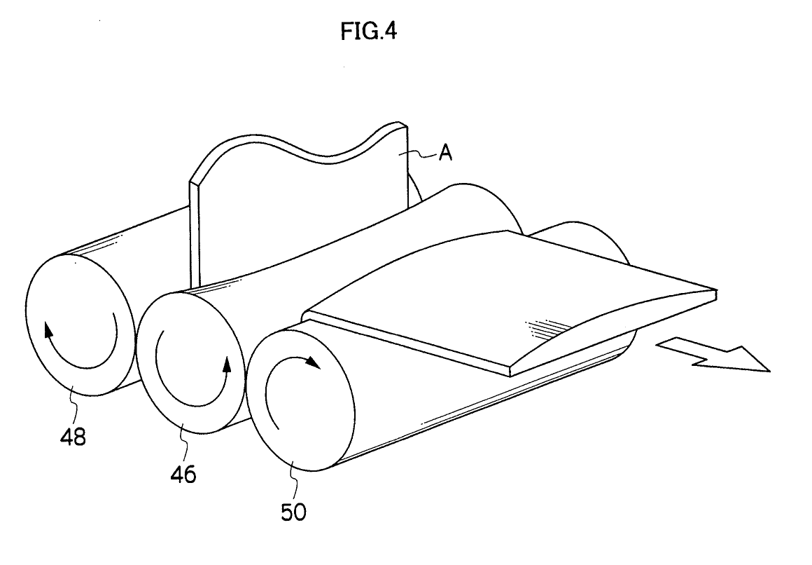

As expanded views of the molding and cooling rollers in FIG. 3A and FIG. 4 show, the mold roller 46 is formed in a concave shape thinner in the middle and thicker at the two ends, and the nip roller 48 is formed flat. Thus, an inverted shape for molding the uneven thickness resin sheet is formed on the roll face of the mold roller 46. This causes the high-temperature resin sheet A extruded from the die 44 to be shaped into a semicylindrical shape by being squeezed (nipped) under a prescribed nip pressure between the mold roller 46 and the nip roller 48. The material of the mold roller 46 can be selected from various iron or steel products including stainless steel, copper, zinc, brass, what has one of these metals as the core and is lined with rubber on the surface, one of these metals plated with HCr, Cu, Ni or the like, ceramics and various composite materials.

For the formation of the inverse semicylindrical shape on the mold roller surface, usually a combination of cutting with an NC lathe and buffing is preferable, though the choice of the method depends on the material of the roller surface. Alternatively, some other known machining method (such as cutting, ultrasonic machining or electrical discharge machining) can be used as well. The surface roughness Ra, averaged on the center line, of the mold roller surface should preferably be no more than 0.5 μm, or more preferably no more than 0.2 μm. The mold roller 46 is driven by a driving device (not shown) at a prescribed peripheral velocity in the direction of the arrow in FIG. 4.

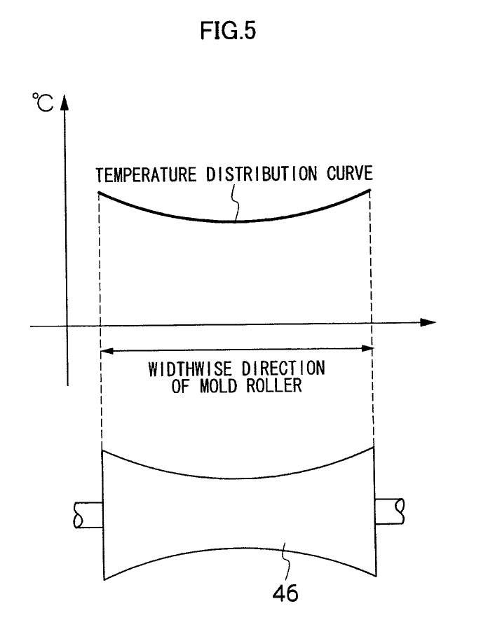

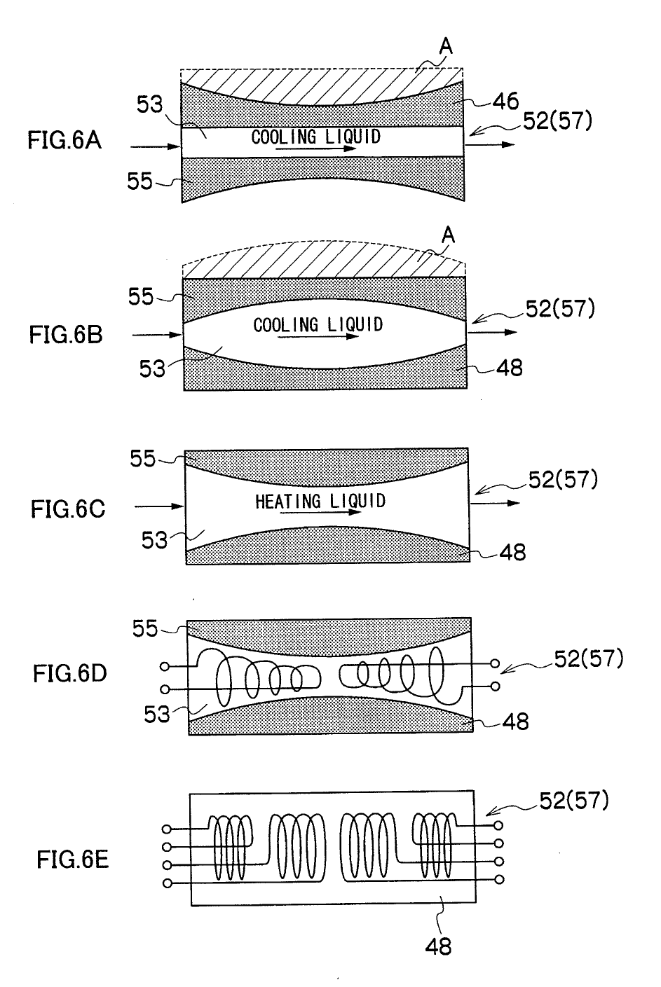

Further, the mold roller 46 is equipped with a device for so providing a cooling temperature distribution in the widthwise direction of the resin sheet as to be substantially identical with the semicylindrical shape as shown in FIG. 5. As shown in FIG. 6A, a preferable configuration for such cooling control device 52 is one in which temperature-controlled cooling liquid is let flow through a channel 53 of the same bore formed from one toward the other of the roller. The supply and discharging of this cooling liquid can be realized with a configuration in which a rotary joint is provided at an end of the roller. As is seen from FIG. 6A, the mold roller 46 is thicker at its two ends, which make it difficult for the cold heat of the mold roller 46 to be transferred to the thin end parts of the resin sheet A. Conversely, the middle part of the mold roller 46 is thinner, which facilitates the transfer of the cold heat of the mold roller 46 to the thicker middle part of the resin sheet A. This enables the velocity of cooling to be uniformized in the widthwise direction of the resin sheet. Incidentally, the roller thickness differentiation in the mold roller 46 can be achieved with a heat insulator 55, for instance. The heat conductivity of the heat insulator 55 should preferably be not above 1 W/mK at room temperature, and suitable materials for the insulator include polyimide resin and glass.

As shown in FIG. 3A, FIG. 3B and FIG. 4, the nip roller 48 is arranged opposite the mold roller 46, and is intended to squeeze the resin sheet A together with the mold roller 46. The material of the nip roller 48 can be selected from various iron or steel products including stainless steel, copper, zinc, brass, what has one of these metals as the core and is lined with rubber on the surface, one of these metals plated with HCr, Cu, Ni or the like, ceramics and various composite materials.

In particular, the relationship between the mold roller 46 and the nip roller 48 should preferably be such that a taper 46A is formed at each end of the mold roller 46 and, when it squeezes the resin sheet A between itself and the nip roller 48, the parts of the resin sheet A meeting the tapers are cut as shown in FIG. 3B. The reason for the preferability of this relationship is that the two ends (ears) of the resin sheet A extruded from the die 44 tend to become thicker than desired and the thickened parts would contribute to warping at later steps of the process. Since the mold roller 46 and taper tops 46B come into contacted with the nip roller 48 and become susceptible to wear, it is preferable to ultra-harden the contact parts with an ultra-hard material, such as tungsten carbide, or by quenching. It is similarly preferable for the mold roller 46 and the peeling roller 50 to have their contact parts to be ultra-hardened with an ultra-hard material, such as tungsten carbide, or by quenching.

It is preferable for the surface of the nip roller 48 to be specularly machined, preferably with a surface roughness Ra, averaged on the center line, of no more than 0.5 μm, or more preferably no more than 0.2 μm. Such a smooth surface can place the rear surface of the resin sheet A after molding in a satisfactory state. The nip roller 48 is driven by a driving device (not shown) at a prescribed peripheral velocity in the direction of the arrow in FIG. 4. A configuration in which no driving device is provided for the nip roller 48 is also possible, but it is preferable to equip the roller with driving device because the rear surface of resin sheet A can be placed in a satisfactory state in this way.

The nip roller 48 is provided with a pressurizing device (not shown), which enables the resin sheet A between this roller and the mold roller 46 to be squeezed under a prescribed pressure. The pressurizing device, so configured as to apply a pressure in the normal direction at the contact point between the nip roller 48 and the mold roller 46, and one of various known devices such as motor driving device, an air cylinder and a hydraulic cylinder can be applied.

The nip roller 48 can be so configured as to make it difficult to be bent by the reactive force to the squeezing power. Such a configuration may be one in which a backup roller (not shown) is disposed behind the nip roller 48 (on the side reverse to the mold roller 46), another in which a crown shape (high at the center) is used, a roller configuration in which strength is so distributed as to increase the rigidity of the roller in the central part in the axial direction, or a combination of some of these configurations.

It is also preferable for the nip roller 48, like the mold roller 46, to be equipped with the cooling control device 52 for so providing a cooling temperature distribution in the widthwise direction of the resin sheet as to be substantially identical with the semicylindrical shape (see FIG. 5). As the cooling control device 52 to be provided on the nip roller 48, any of the ones illustrated in FIG. 6B through FIG. 6E, for instance, can be suitably used. FIG. 6B shows a case in which cooling liquid is let flow through the crown-shaped channel 53 formed within the nip roller 48. This makes the two ends of the nip roller 48 thicker, which would make it difficult for the cold heat of the nip roller 48 to be transferred to the two thin ends of the resin sheet A. Conversely, the middle part of the nip roller 48 is thinner, which facilitates the transfer of the cold heat of the nip roller 48 to the thicker middle part of the resin sheet A. This enables the velocity of cooling to be uniformized in the widthwise direction of the resin sheet. Any of a variety of roller structures can be applied, including a spiral roller, a drilled roller and a jacket roller.

The cooling control device 52 shown in FIG. 6C represents a case in which heating liquid is let flow through a concave channel 53. In this case, too, as the temperature distribution is formed in the widthwise direction of the resin sheet, the velocity of cooling can be uniformized in the widthwise direction of the resin sheet. The heating liquid in this case obviously is lower in temperature than the resin sheet A.

The cooling control device 52 shown in FIG. 6D represents a case in which a sheath heater is embedded in place of the heating liquid in the case shown in FIG. 6C. FIG. 6E shows a case in which a plurality of induction heaters (IH heaters) are disposed in the widthwise direction of the roller to make the heating temperature controllable in the widthwise direction of the roller. Other applicable heating methods include ones using a band heater, a silicon rubber heater of a steam heater.

Further, as shown in FIG. 3A, FIG. 3B and FIG. 4, the peeling roller 50 is arranged opposite the mold roller 46, and is intended to enable the resin sheet A to be peeled off the mold roller 46 by having the resin sheet A wound around it. The peeling roller is arranged 180 degrees downstream of the mold roller 46. It is preferable for the surface of the peeling roller 50 to be machined in specular finish. Such a surface enables the rear face of the molded resin sheet A to be in a satisfactory state. The surface roughness Ra of the peeling roller 50, averaged on the center line, should preferably be no more than 0.5 μm, or more preferably no more than 0.2 μm. The material of the peeling roller 50 can be selected from various iron or steel products including stainless steel, copper, zinc, brass, what has one of these metals as the core and is lined with rubber on the surface, one of these metals plated with HCr, Cu, Ni or the like, ceramics and various composite materials. The peeling roller 50 is driven by a driving device (not shown) at a prescribed peripheral velocity in the direction of the arrow in FIG. 4. A configuration in which no driving device is provided for the peeling roller 50 is also possible, but it is preferable to equip the roller with driving device because the rear surface of resin sheet A can be placed in a satisfactory state in this way.

It is also preferable for the peeling roller 50, like the mold roller 46 and the nip roller 48, to be equipped with the cooling control device 52 for so providing a cooling temperature distribution in the widthwise direction of the resin sheet as to be substantially identical with the semicylindrical shape (see FIG. 5).

To enable the roller surface temperatures of the mold roller 46, the nip roller 48 and the peeling roller 50 to be monitored in the widthwise direction of the rollers, it is preferable to dispose a plurality of surface temperature measuring device (not shown). These surface temperature measuring device can be selected from a variety of known measuring devices including infrared thermometers and radiation thermometers.

As the velocity of cooling in the widthwise direction of the resin sheet of the semicylindrical shape can be uniformized at the molding/cooling step 14 configured in this way, it is possible effectively restrain warping of the resin sheet A at the molding/cooling step 14. The resin sheet A having gone through the molding/cooling step 14 is then handed over to the slow cooling step 16.

The slow cooling step (or annealing step) 16 is provided to prevent the temperature of the resin sheet A from varying rapidly downstream of the peeling roller 50 as shown in FIG. 2. If the temperature of the resin sheet A rapidly changes, for instance though the vicinities of the surface of the resin sheet A are in a plastic state, the inside of the resin sheet A is in an elastic state, and contraction due to the hardening of this part deteriorates the surface shape of the resin sheet A. Furthermore, there arises a temperature difference between the front and rear surfaces of the resin sheet A, making the resin sheet A susceptible to warping. This is particularly true where there is a thickness differentiation in the widthwise direction of the resin sheet as in an uneven thickness resin sheet.

A tunnel-shaped slow cooling zone 54 (or annealing zone) having an inlet and an outlet is provided for the slow cooling step 16. In the former part of the slow cooling zone 54, the resin sheet A is subjected to gradual natural cooling while being heated with a heating device 55, while in the latter part of the slow cooling zone 54 the resin sheet A is subjected to forced cooling by exposure to cold air flows.

The heating device 55 to be disposed in the former part of the slow cooling zone 54 can be selected from various known configurations including one in which (warm) air under temperature control is blown from a plurality of nozzles toward the resin sheet A and another in which the resin sheet A is heated with a nichrome wire heater, an infrared heater, dielectric heating device or the like.

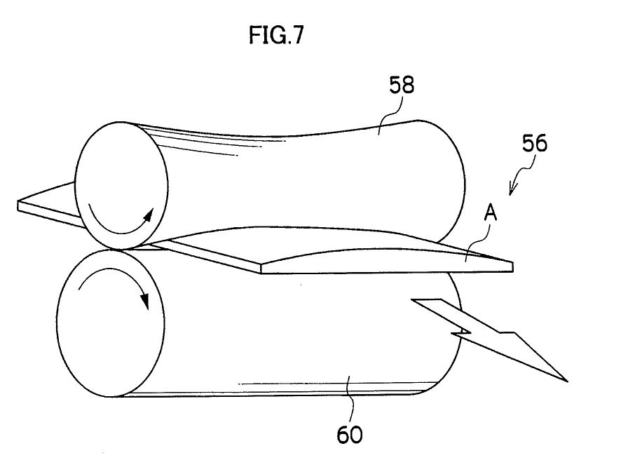

Shape keeping devices 56 are disposed in the former part of the slow cooling zone 54 to so apply an external force to the resin sheet, when the resin sheet A is carried, as to prevent the carriage of the resin sheet A from being obstructed and to enable the resin sheet A to be kept in its original warp-free semicylindrical shape. As the shape keeping device 56, any of what are shown in FIG. 7 through FIG. 9, for instance, can be suitably used.

The shape keeping device 56 shown in FIG. 7 is so configured that one concave roller 58 (uneven thickness-shaped roller) is arranged over the convex face of the semicylindrically shaped resin sheet A and one straight roller 60 whose roll face is flat is arranged over the flat face on the other side to squeeze the resin sheet A under a prescribed pressure.

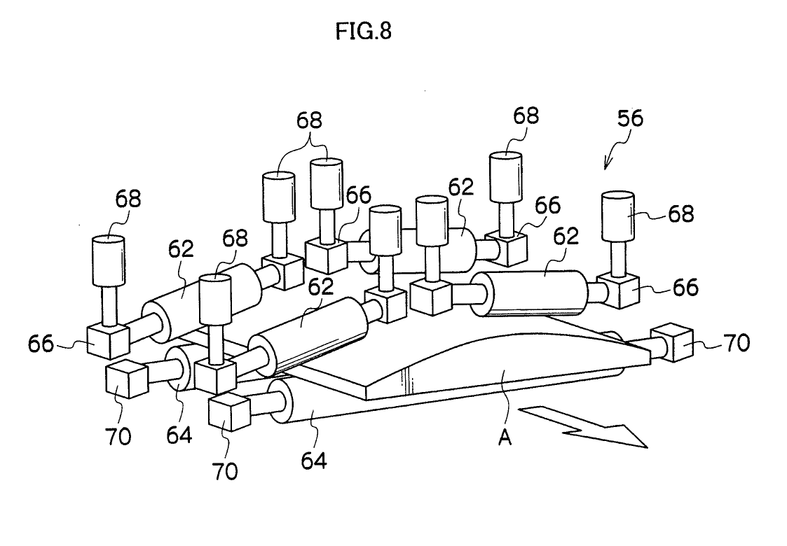

The shape keeping device 56 shown in FIG. 8 is so configured that a plurality of short rollers 62 (comprising two short rollers 62 in FIG. 8) whose roll faces are flat are arranged in a layout split in the widthwise direction of the resin sheet over the convex face of the semicylindrically shaped resin sheet A and one straight roller 64 whose roll face is flat is arranged over the flat face on the other side to squeeze the resin sheet A under a prescribed pressure. The two ends of each of the short rollers 62 are rotatably supported by a bearing 66, which is provided with an air cylinder 68 (external force regulating device). A stroke which extends the piston of the air cylinder 68 serves to adjust the squeezing pressure. A reference sign 70 denotes the bearing of the long roller 64, and the bearing 70 of the long roller 64 and the air cylinders 68 of the short rollers 62 are supported by the body of a slow cooling device (not shown).

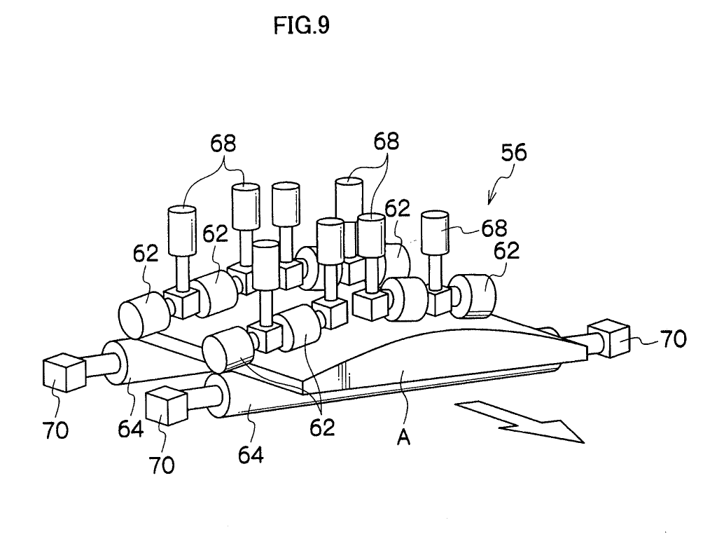

The shape keeping device 56 shown in FIG. 9 has a basically the same structure as what is shown in FIG. 8. The length of the short rollers 62 (four short rollers 62 are disposed here) arranged in the widthwise direction of the resin sheet is made even shorter than those shown in FIG. 8 to enable to accurately squeeze the resin sheet A following its semicylindrical shape. To add, the configurations of the shape keeping device 56 are not limited to those shown in FIG. 7 through FIG. 9, but the essential point is that the device can be anything that can keep the resin sheet A carried under slow cooling in its semicylindrical shape free from warping. For instance, the shape keeping device can also be formed by densely arraying pressing device provided with wheels still shorter than the foregoing short rollers 62 in the widthwise direction of the resin sheet A.

Of the rollers constituting the shape keeping device 56, it is preferable for at least the rollers arranged over the convex face of the resin sheet A to be elastic rollers. The material of the elastic rollers can be selected from, for instance, silicon rubber (SR), styrene butadiene rubber (SBR), chloroprene rubber (CR), chloro-sulfonated polyethylene rubber (CSM), acryl nitrile butadiene rubber (NBR), urethane rubber (U), ethylene propylene terpolymer rubber (EPT), chlorinated polyethylene rubber (CPE), fluoropolymer rubber (FPM), hydrogenated nitrile rubber (HNBR), isobutylene isoprene rubber (IIR) and Hypalon (CMS), but the available materials are not limited to these.

It is further preferable for the shape keeping device 56 shown in FIG. 7 through FIG. 9 to be provided with slow cooling control device 57 for so providing a slow cooling temperature distribution (see the temperature distribution curve in FIG. 5) in the widthwise direction of the resin sheet as to be substantially identical with the semicylindrical shape of the mold roller. As the concave roller 58 and the roller 60 constituting the shape keeping device 56 of FIG. 7, the slow cooling control device 57 if a similar structure to what was described with reference to FIG. 6 can be used. Where the short rollers 62 of FIG. 8 and FIG. 9 are used, it is necessary to form the aforementioned slow cooling temperature distribution of the plurality of short rollers 62 arrayed in the widthwise direction of the resin sheet.

By configuring the slow cooling step 16 as described above, even if an internal stress (internal force) which would give rise to a warp within the resin sheet A arises at the slow cooling step 16, the resin sheet A, as the resin sheet A is held in its original warp-free semicylindrical shape by the pressure (external force) provided by the shape keeping device 56, is slow-cooled without being warped and the internal stress is also eased gradually. Even if the resin sheet A is warped at the molding/cooling step 14, it is slow-cooled in a state wherein the warp is forcibly corrected by the pressure from the shape keeping device 56 at the slow cooling step 16, the internal stress which gives rise to the warp is also eased gradually.

In this case, as the shape keeping device 56 are so configured that the roller arranged toward the semicylindrically shaped face of the resin sheet A follows the semicylindrically shaped face, application of a pressure does not damage the semicylindrically shaped face of the resin sheet A. Furthermore, as it is difficult for any gap to be formed between the semicylindrically shaped face and the roll face, the resin sheet A can be accurately kept in its original warp-free semicylindrical shape.

Further, as the velocity of slow cooling in the widthwise direction of the resin sheet of the semicylindrical shape is uniformized by the slow cooling control device 57, slow cooling can be so accomplished as not let the sheet be warped at the slow cooling step 16. Even if the resin sheet A is warped at the molding/cooling step 14 preceding the slow cooling step 16, the internal stress can be eased while correcting the warp.

In this case, it is preferable for the surface temperature of the resin sheet A which comes into contact with the first shape keeping device 56 disposed at the inlet to the slow cooling zone 54 to be not above the glass transition temperature Tg° C. but not below Tg-30° C., the surface temperature of the resin sheet A at the outlet of the former part of the slow cooling zone 54, namely at the time the holding by the shape keeping device 56 ends to be not above Tg-20° C. but not below Tg-80° C., more preferably not above Tg-50° C. but not below Tg-60° C.

The spacing of the shape keeping device 56 to be arranged in the slow cooling zone 54 should preferably be not more than 1000 mm in the direction of carrying the resin sheet A, more preferably not more than 500 mm. The pressure under which the resin sheet A is squeezed by the shape keeping device 56 should preferably be not above 200 kgf/cm but not below 10 kgf/cm in line pressure, more preferably not above 50 kgf/cm but not below 30 kgf/cm.

In the latter part of the slow cooling zone 54, a plurality of air nozzle devices 74 which blow out cold air flows from above and underneath the resin sheet A are disposed thereby to float and carry the resin sheet A. Known devices for carrying a web-shaped load can be used as the air nozzle devices 74. This arrangement enables the resin sheet A to be cooled to around normal temperature in a state of being not intact with the rollers.

Next, as shown in FIG. 2, the resin sheet A cooled at the slow cooling step 16 is picked up by a nip type feed roller 76 and handed over to the warp measuring step 18.

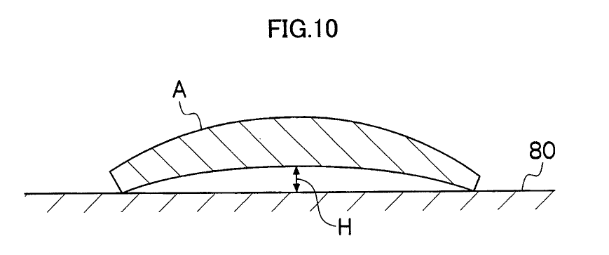

At the warp measuring step 18, whether or not the warp of the resin sheet A meets a prescribed standard is measured with a warp measuring instrument 78. To describe here the warp with reference to the semicylindrically shaped resin sheet A by way of example, when the rear face (the flat face) of the resin sheet A cut into a size of 600 mm in length and 1100 mm in width is placed on the top face of a planar measuring table 80 as shown in FIG. 10, the maximum distance H between the resin sheet A and the measuring table 80 is referred to as the extent of warp. As the prescribed standard of the extent of warp is set according to the intended use of the resin sheet A and the user's requirements, measurement with the warp measuring instrument 78 is to determine whether or not the warp meets such a prescribed standard. As the warp measuring instrument 78, for instance a system which causes an electrostatic sensor or the like to scan the surface (outer circumference) of the resin sheet A, measures the distance (shape) between the resin sheet A and the electrostatic sensor and figures out the extent of warp from a relationship prepared in advance between the measure value and the extent of warp. If the extent of warp measured with the warp measuring instrument 78 is found surpassing the prescribed standard, that finding is fed back to the molding/cooling step 14 and the slow cooling step 16 to uniformize the velocity of cooling and the velocity of slow cooling in the widthwise direction of the resin sheet. Thus, a semicylindrically shaped temperature distribution substantially similar to the mold roller 46 (see FIG. 5) is formed in the widthwise direction of the resin sheet by the cooling control device 52 at the molding/cooling step 14 and by the slow cooling control device 57 at the slow cooling step 16, and the velocity of cooling and the velocity of slow cooling in the widthwise direction of the resin sheet are thereby uniformized.

In this process, as the semicylindrically shaped resin sheet A is or is not warped depending on the type of the semicylindrical shape of the degree of uneven thickness distribution, the feedback is required only when the warp surpasses the prescribed standard. If the velocity of cooling and the velocity of slow cooling in the widthwise direction of the resin sheet are rigidly uniformized in spite of the absence of warp, the result may prove rather adverse.

As shown in FIG. 2, the loading step 26 equipped with the laminating step 22 and the trimming/cutting step 24 equipped with a stocker 79 are provided in that order downstream of the warp measuring step 18. Of these steps, the laminating step 22 is a step of sticking protective films (films of polyethylene of the like) to the front and rear surfaces of the resin sheet A, whereby protective films 84 unwound from a pair of reels 82 are so brought together as to sandwich the resin sheet A between them, and are laminated as they pass a nip roller 86.

At the trimming/cutting step 24, the two ends (ears) of the resin sheet A in the widthwise direction are cut off and the resin sheet A is trimmed to a prescribed length. As a cutter 88, a guillotine type cutter comprising a receiving edge 88A and a pressing edge 88B can be suitably used as shown in FIG. 2, but this is not the only choice. As a trimmer 90, a laser cutter 90A as shown in FIG. 2 or an electronic beam cutting device can be suitably used, but these are not the only choice.

In the apparatus for manufacturing uneven thickness resin sheet according to the invention configured as described above, the belt-shaped resin sheet A extruded from the die 44 is molded into a semicylindrical shape by squeezing it between the mold roller 46 and the nip roller 48 and, after cooling for solidification, the resin sheet A is peeled off the mold roller 46 by the peeling roller 50. The resin sheet A peeled off the mold roller 46 is slow-cooled by carrying it in the horizontal direction past the slow cooling zone 54, cut into the prescribed length in a product pickup section downstream in a warp-freed state, and accommodated as a finished resin sheet A. The velocity of extruding the resin sheet A out of the die 44 may be 0.1 to 50 m/minute, preferably 0.3 to 30 m/minute. Therefore, the peripheral velocity of the mold roller 46 is set substantially equal to this. To add, the velocity fluctuations of the mold roller 46, the nip roller 48 and the peeling roller 50 should preferably be kept within ±1% of the respective set values. It is further preferable for the resin sheet A in the position of the peeling roller 50 at a temperature not above the softening point Ta of the resin. Where the resin sheet A is made of polymethyl methacrylate resin, the temperature of the peeling roller 50 can be set between 50 and 110° C.

In fabricating such an uneven thickness resin sheet according to the invention, as a pressure is so applied by the shape keeping device 56 to the resin sheet A as not to obstruct the carriage of the resin sheet A at least in the former part of the slow cooling step 16, and the resin sheet A is slow-cooled while holding it in its original warp-free semicylindrical shape, the uneven thickness resin sheet fabricated by extrusion molding is prevented from being warped. Even if it is warped at the molding/cooling step 14, the warp can be corrected at the slow cooling step 16.

In this case, it is effective for restraining the warping of the uneven thickness resin sheet to perform draw control on the peripheral velocities of the rollers used at and after the molding/cooling step 14 whereby the peripheral velocity is made greater as the process advances farther downstream. Furthermore, appropriate control of the gap between the mold roller 46 and the nip roller 48 at the molding/cooling step is effective for restraining the warping of the uneven thickness resin sheet A.

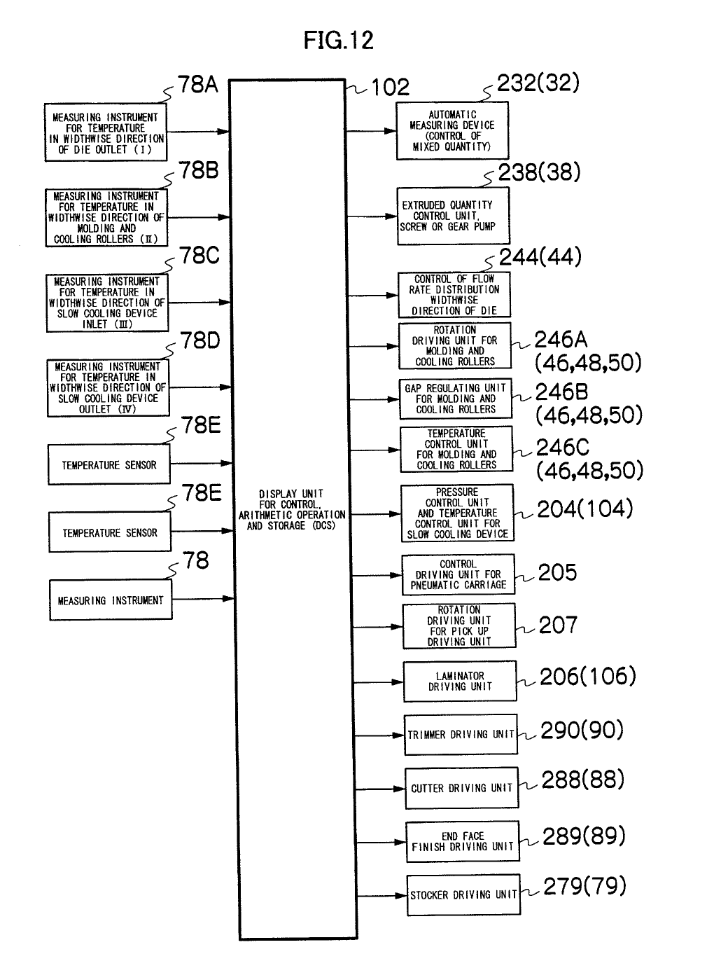

FIG. 11 and FIG. 12 illustrate a control system for an apparatus for manufacturing uneven thickness resin sheet. The measuring instruments shown in FIG. 11 and FIG. 12 include, in addition to the warp measuring instrument 78 described above, a thickness gauge for measuring the thickness the resin sheet A, a transmissivity gauge for measuring the light transmissivity of the resin sheet A, a roughness gauge for measuring the surface roughness of the resin sheet A and a retardation gauge measuring the retardation of the resin sheet A among others.

As shown in FIG. 11 and FIG. 12, various measured data obtained with the measuring instruments like 78, 78A to 78D, 302, 304, 306, 308 and the temperature sensors 78E are inputted to a distributed control system (DCS) 102 including a programmable logic controller (PLC, or sequencer). Also, operational data are inputted from hardware units to the DCS 102. The DCS 102, besides storing the measured data and the operational data, performs arithmetic operations for appropriate control of the hardware units on the basis of the measured data and the operational data. Control signals obtained by the arithmetic operations are outputted to the hardware units including the automatic measuring machine, mixer, hopper, extruder, die, molding and cooling rollers, slow cooling machine 104 and sorting device 108. The sorting device 108 is an apparatus for rejecting defective resin sheets out of the production line into a trash box 110. Resin sheets failing to meet requirements regarding warps, thickness, transmissivity, surface roughness, retardation and so forth are rejected as being defective.

Specific controls of hardware items by the DCS 102 include, as shown in FIG. 12, the mixing quantity control (232) by the automatic measuring machine 32 and the control (238) with a constant volume pump, such as a screw pump or a gear pump, control (244) of the quantity of molten resin from the extruder toward the die 44 at the raw material preparing step. At the raw material preparing step, the flow rate of the resin sheet in the widthwise direction of the die is controlled. At the molding/cooling step, the rotational driving units 246A of the molding and cooling rollers (the mold roller 46, nip roller 48, and peeling roller 50) are controlled, a gap driving unit 246B for regulating gaps between the rollers is controlled, and each temperature control unit 246C is controlled. In the former part of the slow cooling step, the control (204) of the temperature control unit and that of the pressure control unit of the shape keeping device are accomplished, and in the carriage afloat in the latter part, an air carriage driving unit 205 is controlled. Also, a feed roller (pickup roller) driving unit 207, a laminator driving unit 206, a trimmer driving unit 290, a cutter driving unit 288, an end face finish driving unit 289 and so forth are controlled.

Although a case of fabricating semicylindrically shaped uneven thickness resin sheets was described regarding the first embodiment, the invention is not limited to such uneven thickness resin sheets, but can also be applied to uneven thickness resin sheets having a thickness distribution in the direction of the resin width, such as wedge-shaped uneven thickness resin sheets. Such wedge-shaped uneven thickness resin sheets can be manufactured by fabricating semicylindrically shaped uneven thickness resin sheets and cutting them into halves.

### Second Embodiment of the Invention

A second embodiment of the invention concerns a technique by which the resin sheet A is prevented from being warped or distorted by regulating into a prescribed state the temperature distribution in the widthwise direction of the resin sheet A extruded from the die 44 at the molding/cooling step 14 and the slow cooling step 16 in the manufacture of uneven thickness resin sheets. Although the invention is applied to both the molding/cooling step 14 and the slow cooling step 16 in this second embodiment, the invention can as well be applied to only one of the two steps.

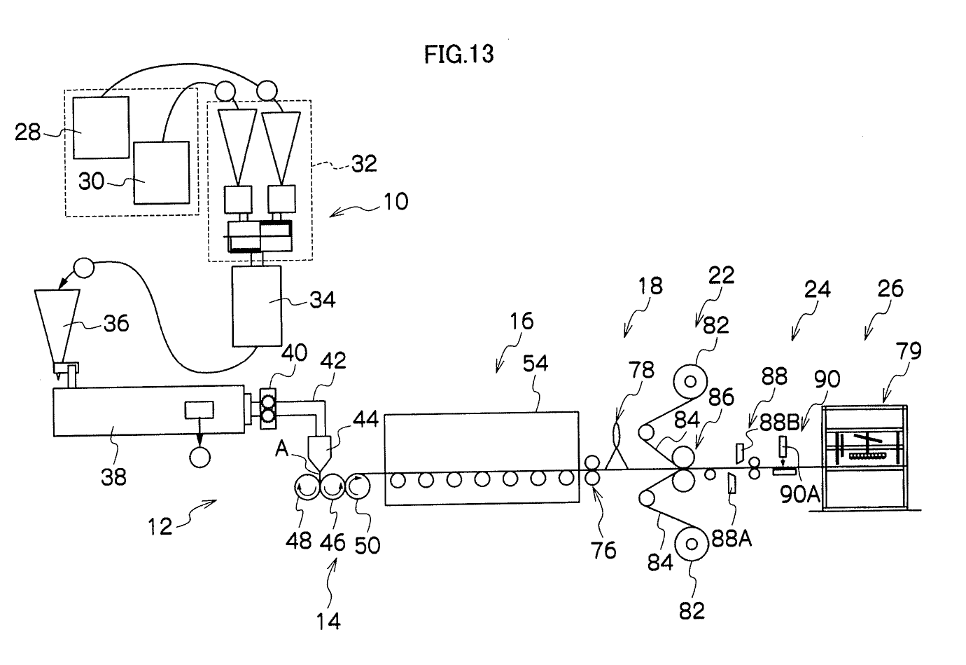

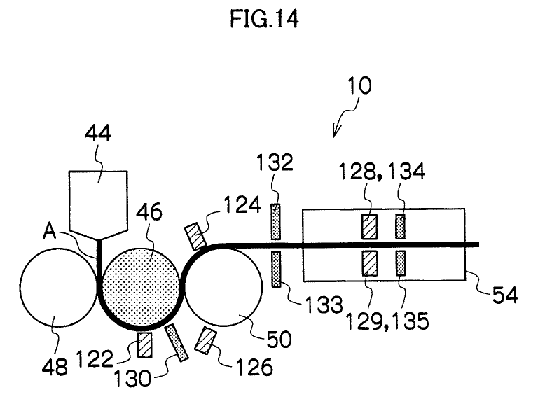

The basic flow of steps in the fabrication of uneven thickness resin sheets is the same as that charted in FIG. 1 which concerns the first embodiment. FIG. 13, which is a conceptual diagram of the overall configuration of an apparatus in the second embodiment, shows only the rollers for carrying the resin sheet A within the slow cooling zone 54. Therefore, details regarding the molding/cooling step 14 and the slow cooling step 16 which characterize the second embodiment of the invention and temperature controls to be performed at the molding/cooling step 14 and the slow cooling step 16 will be described with reference to FIG. 14 through FIG. 16.

As shown in FIG. 13 through FIG. 16, the uneven thickness resin sheet production line is configured of the die 44 for shaping raw material resin melted by the extruder 38 into a belt shape, the mold roller 46 on whose surface an uneven thickness shape is formed, the nip roller 48 arranged opposite the mold roller 46, the peeling roller 50 arranged opposite the mold roller 46, heating device or cooling device 122, 124, 126, 128 and 129, and the slow cooling zone 54. The heating device or cooling device 122, 124, 126, 128 and 129 are controlled with temperatures respectively detected by sensors 130, 132, 133, 134 and 135 to enable the temperature distribution to be uniformed in the widthwise direction of the resin sheet A or to follow a prescribed temperature distribution pattern.

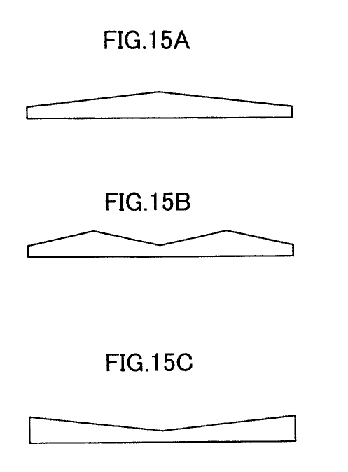

An inverted shape for molding the uneven thickness resin sheet is formed, as shown in FIG. 15A through FIG. 15C for instance, on the surface of the mold roller 46. FIG. 15A through FIG. 15C show sections of the resin sheet A after being molded. Thus, the rear face of the resin sheet A is planar, and a linear uneven thickness shaped-face parallel to the running direction is formed on the front surface of the resin sheet A. Therefore, an endless groove of the inverted shape of the molded resin sheet A may be formed on the front surface of the mold roller 46 as shown in FIG. 15A through FIG. 15C. Details of the uneven thickness shape of the front surface of the resin sheet A will be described afterwards. FIG. 15B shows a case in which two joined reams of the semicylindrically shaped resin sheets A are to be molded, while FIG. 15C shows a case in which two joined reams of wedge-shaped resin sheets A are to be molded. When these reams are to be put to use, they are cut in the middle into two separate reams.

The slow cooling zone 54 is tunnel-shaped in the horizontal direction as shown in FIG. 14, using a configuration having temperature regulating device within the tunnel to allow the cooling temperature profile for the resin sheet A to be controlled. For the temperature regulating device may use one of various known configurations including one in which temperature-controlled air (hot or cold) is blow from a plurality of nozzles toward the resin sheet A and another in which the front and rear surfaces of the resin sheet A are heated by heating device (nichrome wire heater, an infrared heater, dielectric heating device or the like). Incidentally, the temperature regulating device is intended for controlling the cooling temperature profile of the whole resin sheet A, and temperature control device to be described below is to serve a different purpose, namely to control the temperature distribution in the widthwise direction of the resin film.

The apparatus for manufacturing uneven thickness resin sheet according to the invention, mainly configured by heating device or cooling device 122, 124, 126, 128 and 129, is provided with a temperature control device for controlling the temperature distribution in the widthwise direction of the resin sheet A. The temperature control device so controls temperatures as to uniformize the temperature distribution in the widthwise direction of the resin sheet A, and thereby enables the resin sheet A to be fabricated in the desired shape. It may be more preferable for some shapes, in order to restrain distortion and warping, to have a specific temperature distribution in the widthwise direction of the resin sheet A. In such a case, control is so performed as to achieve that temperature distribution pattern. Incidentally, while the following description refers to a case in which heating devices are used, they can be replaced by cooling device or both heating device and cooling device can be used at the same time.

It is preferable to provide the temperature control device with sensors 130, 132, 133, 134 and 135 respectively matching the, heating device 122, 124, 126, 128 and 129. In the configuration shown in FIG. 14, the sensor 130 matches the heating device 122, the sensor 132 matches the heating device 124, the sensor 133 matches the heating device 126, the sensor 134 matches the heating device 128, and the sensor 135 matches the heating device 129. The temperatures can be controlled by detecting temperatures with these sensors and obtaining appropriate PID values for feeding back to the heating device or cooling device. This can be accomplished by any known appropriate method, such as giving an impulse and determining the value from the response thereto.

As the sensors and heating device (or cooling device), any known devices which do not come into contact with the resin sheet can be used with no particular limitation. Radiation thermometers can be preferably used as non-contact sensors, preferable heating devices are infrared heater, and preferable cooling devices are spot coolers. However, for accurate temperature control in the widthwise direction, what can be effective spot heating or cooling are preferable.

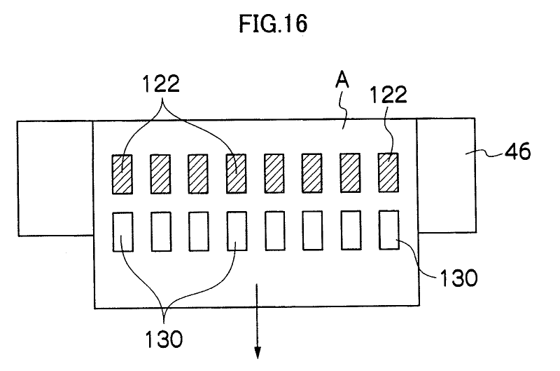

FIG. 16 shows a view from underneath of the mold roller 46 part on the production line 10 of uneven thickness resin sheets wherein the arrangement of the heating device 122 and the sensor 130 is illustrated. It is preferable a plurality each of heating device 122 and sensors 130 to be disposed in the widthwise direction of the resin sheet A as shown in FIG. 16. By arranging the plurality of heating device 122 at short intervals in the widthwise direction, highly accurate control is made possible. However, if heating device in one position can heat a large area, overall control is made difficult by its possible interference with the adjoining heating device, it is preferable to set the number of heating device and the distances between heating device appropriately.

Regarding the sensors 130, they can be arranged close to one another, and a larger number of them than the heating device 122 can be disposed. By increasing the number of sensors 130, more accurate temperature control is made possible. If quickly responsive sensors 130 are used, temperature detection is made possible by scanning the sensors 130 in the widthwise direction of the resin sheet A, and accordingly the number of sensors 130 can be minimized. In FIG. 16, equal numbers of sensors 130 and heating device 122 are disposed, but this equality is not absolutely required, and the number of sensors 130 may be greater or smaller than that of heating device 122.

Regarding the numbers of heating device 122 and of sensors 130, a case in which they are arranged on the mold roller 46 has been described with reference to FIG. 16, but they can as well be arranged similarly elsewhere.

It is preferable for the positions of the sensors 130 and the heating device 122 to be changeable in the widthwise direction. More specifically, it is preferable for the sensors 130 and the heating device 122 to be repositioned to the thickest or thinnest part of the uneven thickness resin sheet. By making them movable, it is made possible to adapt temperature control to the shape of the final product and achieve more accurate shape control.

It is preferable for the sensor 130, 132, 133, 134 and 135 and the heating device 122, 124, 126, 128 and 129 to be arranged on the mold roller 46 or the peeling roller 50 or in the slow cooling zone 54 and in two more positions. The greater the number of positions, the more accurate temperature control is made possible. However, the determination of this aspect should preferably take into account the manufacturing cost and fitting space of the apparatus.

Further, it is preferable for the sensors 130, 132, 133, 134 and 135 and the heating device 122, 124, 126, 128 and 129 to be disposed on the front surface and the rear surface of the resin sheet A. By heating the resin sheet A from the front surface and the rear surface, a temperature distribution uniform in the depthwise direction of the resin sheet A even where the uneven thickness resin sheets to be manufactured are thick. Highly accurate temperature control is made possible to achieve the desired shape.

In the configuration shown in FIG. 14, only one surface of the resin sheet A can be arranged over the mold roller 46, but arrangement on both surfaces of the resin sheet A is achieved in the slow cooling zone 54. Although the peeling roller 50 cannot be arranged on the rear surface of the resin sheet A, heating the peeling roller 50 could address this problem.

In the context of the description of the present invention, “the front surface of the resin sheet” means the surface on which the uneven thickness shape is formed by the mold roller 46, and “the rear surface of the resin sheet” means the surface squeezed by the nip roller 48.

The mold roller 46 and the nip roller 48 may be equipped with temperature regulating device. The roller setting temperatures of the mold roller 46 and the nip roller 48 can be optimized according to the material of the resin sheet A, the temperature (e.g. at the slit outlet of the die 12) of the resin sheet A when molten, the velocity of carrying the resin sheet A, the outer diameter of the mold roller 46 and the convexo-concave pattern shape of the mold roller 46 among other factors.

For these temperature regulating device of the mold roller 46 and the nip roller 48, the method described regarding the first embodiment with reference to FIG. 6 can be used. Thus, a configuration in which temperature-regulated oil is circulated within the rollers can be preferably adopted. The supply and discharge of this oil can be accomplished by providing rotary joints at the ends of the rollers. Other known forms of the temperature regulating device include, for instance, a configuration of embedding sheath heaters in the rollers and another of arranging dielectric heating device in the vicinities of the rollers. By disposing such temperature regulating device, a temperature rise of the mold roller 46 and the nip roller 48 due to a high temperate state of the resin sheet A or an abrupt temperature drop can be restrained.

On the production line of uneven thickness resin sheets, a warp measuring instrument for measuring the extent of warp as referred to above can also be disposed. For instance, the surface (outer circumference) of the uneven thickness resin sheet after passing the slow cooling zone 54 is scanned with an electrostatic sensor or the like, the distance (shape) between the resin sheet and the electrostatic sensor is measured and the extent of warp is figured out. By feeding back this value, a more appropriate shape can be achieved.

Next, a resin sheet manufacturing method using the resin sheet production line configured as described above will be described.

As the resin sheet A to be applied to the invention, a thermoplastic resin sheet can be used, made up of one of the raw material resins referred to in the description of the first embodiment. It is also possible to have the resin sheet contain diffusing particles (also known as scattering particles). By adding diffusing particles, the sheet can be made more suitable for use on the light guide panels to be arranged behind various display devices and various optical elements. Although the addition of diffusing particles makes the sheet more susceptible to warping, as the manufacturing method according to the invention can uniformize the temperature in the resin sheet, sheet manufacturing in a steady shape is made possible.

It is preferable for such diffusing particles to be not more than 10 μm in grain size, more preferably not more than 1 μm. The applicable materials of diffusing particles include metals, inorganic materials, organic materials, semiconductors and macromolecular materials. More specifically, the usable materials include silicon dioxide (SiO₂), aluminum oxide (Al₂O₃), titanium oxide (IV) (TiO₂), yttrium oxide (Y₂O₃), magnesium oxide (MgO), zinc oxide (ZnO), carbon (C), silicon (Si), magnesium (Mg), calcium (Ca), silver (Ag), platinum (Pt), titanium (Ti), nickel (Ni), ruthenium (Ru), rhodium (Rh), gallium arsenide (GaAs), aluminum gallium arsenide (AlGaAs), zirconia (ZrO₂), silicon carbide (SiC), silicon nitride (Si₃N₄), zeolite, nanodiamond, nanocrystal, smectite, mica, dendrimer, star polymer, hyper-branched polymer and microporous methyl aluminum phosphonate.

The preferable concentration of diffusing particles to be contained in the particle-containing resin sheet to be manufactured is in the range of 0.005 to 0.5 mass %, more preferably in the range 0.03 to 0.08 mass %.

The belt-shaped resin sheet A extruded from the die 44 is squeezed between the mold roller 46 and the mold roller 46 and the opposite arranged nip roller 48, the inverted form of uneven thickness shape of the front surface of the mold roller 46 is transferred to the resin sheet A and molded, and the resin sheet A is peeled off the mold roller 46 by winding it around the peeling roller 50 arranged opposite the mold roller 46.

The resin sheet A peeled off the mold roller 46 is carried in the horizontal direction, slow-cooled by passing it through the slow cooling zone 54, cut into the prescribed length in a product pickup section downstream in a warp-freed state, and accommodated as a finished resin sheet.

In the fabrication of this resin sheet A, the velocity of extruding the resin sheet A from the die 44 may be 0.1 to 50 m/minute, more preferably 0.3 to 30 m/minute. Therefore, the peripheral velocity of the mold roller 46 is substantially equalized to this. The velocity fluctuation of the rollers should preferably be kept within ±1% of the respective set values.

The pressure of the nip roller 48 against the mold roller 46 should preferably be 0 to 200 kN/m (kgf/cm) in a line pressure equivalent (a converted value based on the supposition that the face contact of each nip roller due to elastic deformation is a line contact), more preferably 0 to 100 kN/m (kgf/cm).

It is preferable for temperature control of the nip roller 48 and the peeling roller 50 to be accomplished for each individual roller. It is also preferable for the resin sheet A in the position of the peeling roller 50 to have a temperature not hither than the softening point Ta of the resin. Where polymethyl methacrylate resin is used for the resin sheet A here, the set temperature of the peeling roller 50 can be between 50 and 110° C.

Next, the convexo-concave pattern shape of the resin sheet surface will be described. FIG. 15A through FIG. 15C show sections of the linearly cut end faces of the molded uneven thickness resin sheet. The rear face of the resin sheet A is planar. It is preferable for the uneven thickness resin sheet fabricated by using the manufacturing method and apparatus according to the invention to be not more than 5 mm in its thinnest part, more preferably not more than 2 mm. The difference between the thickest and thinnest parts of the uneven thickness resin sheet should preferably not less than 1 mm, more preferably not less than 2.5 mm. These dimensions enable the sheet to be made more suitable for use on the light guide panels to be arranged behind various display devices and various optical elements.

Now, the shape described above will result in resin film thickness differences in the resin sheet A extruded from the die 44 after it is wound around the mold roller 46. Therefore, the thicker part of the resin film is slower to be cooled because of its greater thermal capacity, while the thinner part is faster to be cooled. To restrain this temperature differentiation, the heating devices 122 are arrayed as shown in FIG. 16 in the widthwise direction from above the resin sheet A wound around the mold roller 46 as shown in FIG. 14, and the sensors 130 are arrayed downstream similarly to the heating device 122. Then the output temperatures of the heating device 122 are so controlled as to uniformize the temperature in the widthwise direction of the resin sheet A.

This enables the temperature to be uniformized in the widthwise direction of the resin sheet A while the sheet is in contact with the mold roller 46. Further, the heating device 124 are arrayed in the widthwise direction over the resin sheet A wound around the peeling roller 50, the heating device 126 which directly heats the peeling roller 50 is arranged to enable the heating to controlled from the rear surface as well, the temperature sensors 132 and 133 are arranged downstream thereof over both surfaces of the resin sheet A, and the outputs of the heating device 122 and 124 are so controlled as to uniformize the temperature in the widthwise direction. One of the available methods to control the temperature distribution to take on a specific temperature distribution pattern, device which controls the outputs of the heating device, alters the temperature setting and focusing it down on a trial-and-error basis while measuring the quantity of distortion or warping to figure out the temperature distribution.

By using the uneven thickness resin sheet production line shown in FIG. 14, a plurality of heating device were arranged in the widthwise direction as shown in FIG. 16, and uneven thickness resin sheets were fabricated. The uneven thickness resin sheets fabricated were the resin sheets A of the shape shown in FIG. 15A. By fabricating the sheets while uniformly controlling the temperature of the resin sheets A in the widthwise direction, uneven thickness resin sheets having a highly accurate shape free from distortion and warping were successfully obtained. When resin sheets of the shape shown in FIG. 15A without temperature control in the widthwise direction resulted in significant distortion and warping, and the extent of warp was 10 mm or more.

At the slow cooling step 16 in the second embodiment, the shape keeping device 56 in the first embodiment was not used, but the shape keeping device 56 can as well be applied to the second embodiment. Although the control system for the uneven thickness sheet manufacturing apparatus shown in FIG. 11 and FIG. 12 was not referred to in describing the second embodiment, a control system to control the temperature distribution in the widthwise direction of the resin sheet A extruded from the die 44 in a prescribed state may be architected by using the heating device (or cooling device) and the sensors provided for the molding and cooling rollers 46, 48, 50 and the slow cooling machine 104 out of those shown in FIG. 11 and FIG. 12.

1. A method for manufacturing an uneven thickness resin sheet whose thickness is uneven in the widthwise direction of said resin sheet, the method comprising:
an extruding step of extruding molten resin from a die in a belt shape;
a molding/cooling step of cooling and solidifying the extruded resin sheet while molding the same in uneven thickness by nipping the same between a mold roller and a nip roller; and
a slow cooling step of slowly cooling the resin sheet peeled off said mold roller, characterized in that
at least the former part of said slow cooling step has a substep of slowly cooling said resin sheet while holding the resin sheet in the original warp-free uneven thickness shape while so applying an external force to said resin sheet as not to obstruct the carriage of the resin sheet.

2. The method for manufacturing uneven thickness resin sheet according to claim 1, characterized in that
a surface temperature of said resin sheet at the inlet to said slow cooling step is not above a glass transition temperature Tg° C. but not below Tg-30° C.,
a surface temperature of said resin sheet at the time said external force ceases to be applied is not above Tg-20° C. but not below Tg-80° C., and
said external force is not above 200 kgf/cm but not below 10 kgf/cm in line pressure.

3. The method for manufacturing uneven thickness resin sheet according to claim 1, characterized in that a velocity of slow cooling of said resin sheet in the widthwise direction is uniformized.

4. The method for manufacturing uneven thickness resin sheet according to claim 1, characterized in that
said external force is applied by squeezing said resin sheet between rollers from the front and rear faces thereof, and
the roller arranged on the side of an uneven thickness shape-face of the resin sheet is formed to follow the uneven thickness shaped-face.

5. The method for manufacturing uneven thickness resin sheet according to claim 4, characterized in that the roller arranged on said uneven thickness shaped-face side is an uneven thickness roller having the same roller face as said uneven thickness shaped-face.

6. The method for manufacturing uneven thickness resin sheet according to claim 4, characterized in that rollers arranged on said uneven thickness shaped-face side are a plurality of short rollers arrayed in the widthwise direction of the resin sheet.

7. The method for manufacturing uneven thickness resin sheet according to claim 4, characterized in that the roller or rollers arranged on said uneven thickness shaped-face side are an elastic roller or rollers.

8. An apparatus for manufacturing an uneven thickness resin sheet uneven in thickness in the widthwise direction, the apparatus comprising:
an extruding device which extrudes molten resin from a die in a belt shape;
a molding/cooling device which cools and solidifies the extruded resin sheet while molding the same in uneven thickness by nipping the same between a mold roller and a nip roller;
a slow cooling device slowly cools the resin sheet peeled off said mold roller;
a shape keeping device which holds said resin sheet in the original warp-free uneven thickness shape while so applying an external force to the resin sheet as not to obstruct the carriage of the resin sheet;
an external force regulating device which regulates said external force to be applied; and
a slow cooling control device which uniformizes the velocity of slow cooling of said resin sheet to be slow-cooled in the widthwise direction.

9. The apparatus for manufacturing uneven thickness resin sheet according to claim 8, characterized in that said shape keeping device comprises:
a first roller arranged on the uneven thickness shaped-face side of said resin sheet and configured along the uneven thickness shaped-face; and
a straight second roller arranged on the flat face side of said resin sheet.

10. A method for manufacturing an uneven thickness resin sheet whose thickness is uneven in the widthwise direction of said resin sheet, the method comprising:
an extruding step of extruding molten resin from a die in a belt shape;
a molding/cooling step of cooling and solidifying the extruded resin sheet while molding the same in uneven thickness by nipping the same between a mold roller and a nip roller; and
a slow cooling step of slowly cooling the resin sheet peeled off said mold roller, characterized in that:
at least one of said molding/cooling step and said slow cooling step has a temperature control substep of so controlling the temperature of the resin sheet with a heating device or a cooling device as to uniformize the temperature distribution of said resin sheet in the widthwise direction.

11. A method for manufacturing an uneven thickness resin sheet whose thickness is uneven in the widthwise direction of said resin sheet, the method comprising:
an extruding step of extruding molten resin from a die in a belt shape;
a molding/cooling step of cooling and solidifying the extruded resin sheet while molding the same in uneven thickness by nipping the same between a mold roller and a nip roller; and
a slow cooling step of slowly cooling the resin sheet peeled off said mold roller, characterized in that:
at least one of said molding/cooling step and said slow cooling step has a temperature control substep of so controlling the temperature of the resin sheet with a heating device or a cooling device as to cause the temperature distribution of said resin sheet in the widthwise direction to keep a prescribed temperature distribution pattern.

12. The method for manufacturing uneven thickness resin sheet according to claim 10, characterized in that
at said temperature control substep the temperature distribution of said resin sheet in the widthwise direction is detected with a sensor, and
temperature control in the widthwise direction is performed according to the detected value.

13. The method for manufacturing uneven thickness resin sheet according to claim 12, characterized in that
for said temperature control substep, a plurality of said sensors and one of said heating device and said cooling device are installed in the widthwise direction of said resin sheet.

14. The method for manufacturing uneven thickness resin sheet according to claim 13, characterized in that
the positions of said sensors and one of said heating device and said cooling device can be altered in the widthwise direction according to the sectional shape of the final product.

15. The method for manufacturing uneven thickness resin sheet according to claim 10, characterized in that
the method is performed by using a peeling roller for peeling said resin sheet off said mold roller and a slow cooling zone for performing said slow cooling step, and
said sensor and one of said heating device and said cooling device are installed in two or more parts selected from said mold roller part, said peeling roller part and said slow cooling zone.

16. The method for manufacturing uneven thickness resin sheet according to claim 10, characterized in that said uneven thickness resin sheet has a thickness difference between the thickest and thinnest parts of 0.5 mm or more in the widthwise direction of the sheet.

17. The method for manufacturing uneven thickness resin sheet according to claim 10, characterized in that the thickness of the thinnest part of said uneven thickness resin sheet is not more than 5 mm.

18. The method for manufacturing uneven thickness resin sheet according to claim 10, characterized in that at said temperature control substep said resin sheet is heated or cooled from both faces.

19. The method for manufacturing uneven thickness resin sheet according to claim 10, characterized in that said resin sheet contains diffusing particles.

20. An apparatus for manufacturing uneven thickness resin sheets uneven in thickness in the widthwise direction, comprising:
an extruding device which extrudes molten resin from a die in a belt shape;
a molding/cooling device which cools and solidifies the extruded resin sheet while molding the same in uneven thickness by nipping the same between a mold roller and a nip roller; and
a slow cooling device which slowly cools the resin sheet peeled off said mold roller, characterized in that:
at least one of said molding/cooling device and said slow cooling device has a temperature control device which so controls the temperature of the resin sheet with a heating device or a cooling device as to uniformize the temperature distribution of said resin sheet in the widthwise direction.

21. An apparatus for manufacturing uneven thickness resin sheets uneven in thickness in the widthwise direction, comprising:
an extruding device which extrudes molten resin from a die in a belt shape;
a molding/cooling device which cools and solidifies the extruded resin sheet while molding the same in uneven thickness by nipping the same between a mold roller and a nip roller; and
a slow cooling device which slowly cools the resin sheet peeled off said mold roller, characterized in that
at least one of said molding/cooling device and said slow cooling device has a temperature control device of so controlling the temperature of the resin sheet with a heating device or a cooling device as to cause the temperature distribution of said resin sheet in the widthwise direction to keep a prescribed temperature distribution pattern.
